(19) United States
(12) Patent Application Publication
(10) Pub. No.: US 2025/0274671 A1
(43) Pub. Date: Aug. 28, 2025

(54) CAMERA SYSTEM FOR INCREASING THE PERFORMANCE OF A PERCEPTION SYSTEM

(71) Applicant: Robert Bosch GmbH, Stuttgart (DE)

(72) Inventors: Mehrdad Nekouei Shahraki, Weil Der Stadt (DE); Thorsten Baark, Ludwigsburg (DE)

(21) Appl. No.: 19/061,113

(22) Filed: Feb. 24, 2025

(30) Foreign Application Priority Data
Feb. 27, 2024 (DE) 10 2024 201 794.9

(51) Int. Cl. H04N 23/90

(52) U.S. Cl. CPC H04N 23/90

(57) ABSTRACT

A camera system for increasing the performance of a perception system for image correction of an image region. The camera system includes one or more cameras, wherein one or more cameras include a focal length and a field of view, wherein the one or more cameras include a camera type or a camera variant, wherein the one or more cameras can be positioned at different installation heights or object distances from the camera. A virtual camera and/or virtual image is generated from a camera image using the camera system. The focal length and/or the field of view of the virtual image changes dynamically once during an installation or multiple times when the environmental conditions change, depending on an installation height or the object distance.

### CROSS REFERENCE

The present application claims the benefit under 35 U.S.C. § 119 of German Patent Application No. DE 10 2024 201 794.9 filed on Feb. 27, 2024, which is expressly incorporated herein by reference in its entirety.

### FIELD

The present invention relates to a camera system for increasing the performance of a perception system for image distortion correction of an image region. Furthermore, the present invention relates to a method for increasing the performance of a perception system for image distortion correction of an image region. Furthermore, the present invention relates to the use of the camera system.

### BACKGROUND INFORMATION

For applications such as automated valet parking (AVP) that require precise recognition and measurement of objects within a specific distance range, it is critical to carefully select or adjust the camera to meet these requirements. This can be achieved by selecting or designing a camera that has the appropriate sensor resolution, lens and optical field of view (FoV). For example, if the goal is to accurately detect objects in the immediate vicinity of the camera, a wide-angle FoV may be beneficial, since it covers a larger region. Conversely, if comparable accuracy is desired for more distant objects, a camera with a narrower field of view can be selected in order to achieve similar results to the wide-angle camera for objects that are near.

European Patent No. EP 1 038 734 B1 describes a driver assistance device with an ambient imaging device for imaging the environment of the vehicle equipped with the driver assistance device, which comprises a camera for generating an environmental image and a device for generating a synthetic image by superimposing an assumed movement pattern.

A disadvantage of this approach, however, is that it creates a camera system that is specifically designed for a particular scenario or purpose, as a result of which its effectiveness in other situations, such as installation at different heights, is impaired. Furthermore, this may result in a plurality of camera system versions for different applications being combined in a single system, as a result of which the complexity and number of camera variants are inefficiently increased.

German Patent Application No. DE 10 2008 034606 A1 describes a method for representing the environment of a vehicle on a mobile unit that wirelessly receives at least one image signal from the vehicle. Due to at least one image signal, a representation on the mobile unit is generated which contains at least one perspectively arranged virtual plane, on which at least one image is depicted that was recorded with a recording means of the vehicle, which image comprises at least part of the environment of the vehicle.

Germany Patent Application No. DE 10 2020 213147 A1 describes a method for a camera system, in particular a surround view camera system, for an ego vehicle, comprising a control device for controlling the camera system and a plurality of cameras for detecting the environment, wherein the following method steps are provided: recognizing objects that are in the field of view of the cameras, selecting at least one object from the recognized objects based on at least one selection parameter, determining a distance between the selected object and the ego vehicle, setting up a virtual camera that is directed at the selected object, and outputting information about the selected object.

### SUMMARY

According to a first aspect of the present invention, a camera system is provided for increasing the performance of a perception system for image distortion correction of an image region, which system comprises one or more cameras, wherein one or more cameras comprise a focal length with a field of view, wherein the one or more cameras comprise a uniform camera type or a uniform camera variant, wherein the one or more cameras can be positioned at different installation heights or object distances from the camera, wherein a virtual camera and/or virtual image is generated from a camera image by means of the camera system, wherein the focal length and the field of view of the virtual image change dynamically once during an installation or multiple times when the environmental conditions change, depending on an installation height or the object distance.

A camera system comprises a plurality of components, including an image recording unit (for example, a camera, including optical elements, for example a lens) and, if necessary, components for signal processing and transmission. The purpose of the camera system is to detect, process and/or transmit visual information, as a result of which it is suitable for a variety of applications such as photography, video recording and security surveillance.

A perception system is a technical system that is capable of collecting, interpreting and understanding information about its environment. Its purpose is to detect, process and analyze data from the physical world, so that the technical system can perceive and understand its environment. This technological system comprises, for example, a plurality of sensors, cameras, microphones, radar systems, lidar, and other technologies, wherein the sensors detect data such as images, sounds, depth information and other physical parameters. Algorithms and processing units then analyze the collected data to recognize patterns, recognize objects, calculate distances and ultimately develop a comprehensive understanding of the environment. The perception system plays a crucial role in applications such as autonomous driving, where vehicles must have a comprehensive understanding of their environment in order to be able to navigate safely and efficiently. With the perception system according to the present invention, which is arranged as a perception system within an infrastructural environment such as a parking garage, the environment can be completely detected, wherein the detected environment is transmitted, for example via a server, to the autonomous vehicle driving past or situated in the vicinity, in such a way that the vehicle can for example drive or park according to the environment detected by the perception system. In connection with a camera's perception system, the term “image region” refers to the specific part of the environment that is detected and processed by the camera. This comprises the visible region that can be detected by the camera's sensors. The image region is crucial for the camera system to effectively cover the intended surveillance region.

The image region correlates closely with the camera's field of view, which determines the region within the camera's angle of view in which objects and events can be detected. The image region plays a crucial role in the evaluation of, for example, image data, in particular in tasks such as recognizing objects, tracking and analyzing movement patterns. The camera system according to the present invention extends the capabilities of a perception system with a particular focus on optimizing the image region and its image distortion correction.

A camera type refers to the general grouping or classification of a camera determined by its basic properties, purposes or functions. Within each camera type there are different models or versions, which are called camera variants. These variants can comprise differences in particular functions, technologies or design aspects.

For the purposes of the present invention, a focal length of a camera is understood to be a distance between a focal point, the point at which the light rays meet after passing through the camera lens, and a focal point center, the center point of the lens. In the context of the present invention, a dynamic focal length is a function that allows the focal length of a camera lens to be adjusted in order to vary the portion of the image, namely the image region, without the camera itself having to be physically moved. The term “field of view” refers to the angle, measured in degrees, detected by an optical system, such as a camera, sensor or surveillance system. A dynamic field of view in the context of the present invention refers to the ability of a camera and/or cameras of a camera system arranged in infrastructure buildings to adjust its field of view or detection region to changing conditions and requirements. In this connection, the proposed camera system with a dynamic field of view can vary its parameters in real time according to different situations. This comprises the ability to change the angle, perspective or focus in order to accommodate changing circumstances or moving objects. In this case, a variable area refers to a size or space that is not fixed, but can be changed or adjusted.

The term “installation height” refers to the height at which the camera(s) are positioned or mounted in relation to the floor or a floor surface. For example, determining an optimal installation height depends on a variety of factors and varies with the individual specifications of the surveillance system. The proposed camera system has the advantage that it can meet any specification of the perception environment by using the same camera types.

In the connection of a camera system in the sense of the present invention and in particular in applications such as automatic parking, the term “object recognition” refers to the recognition of surrounding objects (for example, the vehicle, other vehicles, pedestrians) or obstacles. For automated parking, accurate object recognition is crucial to ensure safe driving as well as entering and leaving parking spaces. For this purpose, cameras are often used that provide a real-time visual representation of the vehicle's environment and accurately recognize objects. The accuracy and efficiency of the automated parking system depends heavily on the ability of the camera system to recognize objects accurately and reliably. This allows the vehicle to drive precisely, maneuver and interact safely with its environment.

A virtual camera is a mathematical model that simulates the properties of a real camera. These properties comprise aspects such as spatial configuration, perspective, focal length and various other variables. For example, in order to investigate the motion and position of objects, the proposed camera system uses a virtual camera that accurately replicates the viewing angle of a physical camera.

A virtual image is therefore a result of a simulation performed by a virtual camera. It represents visual information based on a simulated camera perspective and simulated parameters. In a perception system, a virtual image can for example contain information about an environment or the location of objects detected by a real or simulated camera.

By using cameras of the same camera type or a variant thereof, the present invention provides a new method to achieve an optimal level of visual perception. With this method of the present invention, a virtual camera or a virtual image is generated from the original camera image, be it the raw image or the corrected image. In particular, the focal length of the virtual image is dynamically adjusted in response to changes in the installation height or the distance between objects and the camera.

According to the present invention, camera systems with cameras play a crucial role in supporting the parking process, for example in a parking garage with an automated parking system. The cameras are stationary at infrastructure facilities such as a parking garage and are strategically positioned along the lanes and parking spaces. The positioning of the cameras can be carried out for example in such a way that they are suspended from the ceiling of the parking garage and their field of view is directed downwards towards the ground. For example, if a vehicle enters the parking garage, the camera system carries out the determination of the exact position and orientation of the vehicle. By changing the focal length and/or the field of view once during installation or multiple times dynamically, the cameras detect the distances to obstacles and lane markings and thus allow for safe driving. In addition, the cameras monitor possible obstacles such as pillars, other vehicles or people while the vehicle navigates through the parking garage. By dynamically changing the field of vision, obstacles are recognized from different distances and angles in such a way that the automatic parking system can provide detailed visual evasion or avoidance instructions.

In an advantageous example embodiment of the camera system provided according to the present invention, the camera(s) is/are super-wide-angle camera(s).

A super-angle camera within the meaning of the present invention is a camera with a field of view of, for example, 120°. The suggested camera can also be a wide-angle camera or another type of camera.

A wide-angle camera is a camera with a wide-angle lens that can detect a larger region than a standard camera with a normal or telephoto lens. A super-wide-angle camera is a camera with a super-wide-angle lens that can detect a larger region than a wide-angle camera, standard camera with a normal or telephoto lens. This is particularly important for recognizing obstacles, for example. When it comes to automatic parking, it is important to have an accurate detection of the environment, in order to be able to drive a vehicle safely in the parking area and maneuver it into a parking space. Due to super-wide-angle or wide-angle cameras, an automatic parking system can make precise decisions and maneuver the vehicle safely. In addition, super-wide-angle cameras or wide-angle cameras help to ensure that a larger perception area is detected by one camera and that the perception system requires fewer cameras to cover the parking area. Free parking spaces are recognized more quickly because they cover a larger region and thus more information is available for decision-making.

In a further advantageous example embodiment of the camera system provided according to the present invention, the generated camera image comprises a raw image or a distortion-free image.

A distortion-free image is generally a recorded image that faithfully reproduces objects and environments, free from significant distortions, such as barrel or pincushion distortions, or other unwanted optical effects. A “raw image” refers to an unprocessed image that comes directly from the camera. Compared to some compressed image formats, a raw image comprises all the data detected by the image sensor, wherein any in-camera processing or compression is omitted. Raw images are stored uncompressed, wherein no data are lost and all information recorded by the image sensor is retained. Raw images can also be post-processed more flexibly, because the exposure, white balance and contrast, for example, can be better adjusted.

Raw images allow for lossless processing, because no data are lost during storage.

In a further advantageous example embodiment of the camera system provided according to the present invention, one or more cameras comprise a dynamic region of interest and the focal length.

In a further advantageous example embodiment of the camera system provided according to the present invention, the camera system comprises an arrangement of a plurality of cameras in a configured position and orientation relative to one another, wherein the position and orientation of the cameras is designed in such a way that optimal coverage of the region to be monitored is achieved.

The camera system of the present invention for increasing the performance of a perception system for image distortion correction of an image region, which system comprises a plurality of cameras arranged horizontally, advantageously offers a highly efficient possibility for monitoring the environment. For example, a horizontal arrangement can be a horizontal line arrangement that allows for effective monitoring along a particular axis of an infrastructure building, such as a parking garage. Alternatively, the camera system can comprise a zonal arrangement, in which the environment to be monitored is divided into zones and cameras are placed in each zone in a targeted manner.

According to a second aspect of the present invention, a method for increasing the performance of a perception system for image distortion correction of an image region is proposed, preferably using the camera system of the present invention described above. According to an example embodiment of the present invention, the method comprises at least the following steps:
detecting an image by performing a camera projection from a spatial environment, wherein a detected image comprises an original camera resolution, wherein the detected image exhibits optical distortion and
distortion correction for an image portion for generating a distortion-free image with a dynamic field of view.

For example, during distortion correction, the recorded image can be adjusted so that the optical distortion is eliminated but the visible image region is reduced. The resulting image, i.e. the distortion-free image generated, is manipulated so that its properties correspond to those of a virtual camera with a similarly reduced field of view. The result of the distortion correction can be a distortion-free image that can under some circumstances show a reduced region of the originally detected image, wherein this region is made compatible with the properties of a corresponding virtual camera.

Due to the method of the present invention, an optical magnification (zoom-in effect) is generated in the distortion-corrected image. For example, in order to maintain a certain image quality, various anti-aliasing techniques, pixel or sub-pixel interpolation techniques can be used to generate the image with a smaller field of view.

A pixel interpolation technique is a process in which new pixel values are calculated to improve the image representation. This can be achieved by averaging the values of neighboring pixels or by using complex mathematical algorithms, as a result of which, for example, smoother transitions and higher image quality are obtained. A subpixel interpolation method is an interpolation method that applies interpolation of individual pixel components on a plane, as a result of which the visual image resolution is improved.

An anti-aliasing technique is a technique that reduces or eliminates one or more artifacts such as aliasing in digital images. Anti-aliasing techniques comprise various methods, such as supersampling, multisampling or post-processing filters for improving the representation of edges and lines, which correspond to the related art and are not discussed further.

In a simple modification of the method presented in the present invention, a region of interest (ROI) or window region of interest (WOI) can be selected in the original image such that only a portion of the original image or only a part of the image of the image sensor is used, or only a part of the image is read out, which is controlled by a ROI/WOI configuration. In such a system, for example using a smaller image or adjusting the size of the resulting image to the target image resolution by resampling or any of the above methods will result in the resulting image having a smaller field of view and ultimately achieving improvements in the perception system.

In a further advantageous embodiment of the method provided according to the present invention, the optical distortion occurs due to a reduction in the first field of view of the distortion-corrected image of a first region or of an image region that is used of the virtual camera.

In a further advantageous embodiment of the method provided according to the present invention, by reducing the size the first region of the distortion-corrected image, a size of the first region is achieved which is similar to the size of the third region. A “size” refers to the spatial detection region that is covered for example by a field of view.

In a further advantageous embodiment of the method provided according to the present invention, the method generates a virtual camera or a virtual distortion-free image from a raw image in one step.

In a further advantageous embodiment of the method provided according to the present invention, a digital or synthetically dynamic zoom-in effect is generated in the resulting image.

The zoom-in effect is, according to the present invention, an interpretation of a distortion correction of the raw image with a virtual camera or a virtual image with a reduced field of view.

The present invention further relates to the use of the camera system for increasing the performance of a perception system for image distortion correction of an image region within an automatic parking system.

In the area of infrastructure, for example in automatic parking, monitoring or detecting the vehicle's surroundings plays a crucial role in safety, efficiency and operational management. An innovative solution for these requirements is presented by camera systems whose focal lengths or fields of view can be changed dynamically. A substantial advantage of such a system is its flexibility. By dynamically changing the focal length and field of view, the cameras can be flexibly adjusted to different infrastructure regions. This allows for precise monitoring of open spaces as well as regions that are not surveyable or have only limited access.

This flexibility also allows for the efficient use of resources. For example, a camera system with a dynamically variable focal length or field of view, instead of a plurality of cameras with a fixed focal length or field of view, can provide equivalent coverage while at the same time reducing resources such as installation costs and energy consumption. This applies, for example, to dynamic environments such as construction sites or event locations, where monitoring requirements often change. In order to meet new requirements, the focal length or field of view can be adjusted without additional installation effort.

A more efficient use of the recorded data is also possible by dynamically changing the focal length or field of view. By being able to detect important details while maximizing the region under surveillance, a camera system with a dynamically variable focal length or field of view can quickly recognize disturbing processes and effectively record events. This not only increases safety, but also makes it easier to manage and analyze the monitoring data.

Furthermore, by using the camera system described in the present invention, it is possible to use a single type of camera that can operate effectively at different installation heights. This eliminates the need to adjust a plurality of camera types for different object distances or installation heights, as a result of which the number of camera types required is significantly reduced.

By minimizing the number of camera types, the costs for design, logic and computing unit, software development, manufacturing, validation and testing, logistics and overall effort are reduced. Furthermore, in applications such as AVP, the camera system can be carefully and strategically designed, taking into account camera attributes, field of view, mounting height and coverage region, resulting in a simpler and less labor-intensive system planning process compared to existing technologies. Furthermore, the camera system developed according to the present invention simplifies installation and commissioning.

### BRIEF DESCRIPTION OF THE DRAWINGS

Example embodiments of the present invention are explained in greater detail with reference to the figures and the following description.

FIG. 1 is a graphical representation of the camera system, according to an example embodiment of the present invention.

FIG. 2 is a representation of the method and a graphic representation of a dynamic image correction, according to an example embodiment of the present invention.

FIG. 3 is a representation of images of an automatic parking system with the dynamic field of view, according to an example embodiment of the present invention.

FIG. 4 is a representation of images of an automatic parking system with the dynamic region of interest, according to an example embodiment of the present invention.

FIG. 5 is a graphical representation of a horizontal arrangement of cameras of the camera system, according to an example embodiment of the present invention.

### DETAILED DESCRIPTION OF EXAMPLE EMBODIMENTS

In the following description of the example embodiments of the present invention, identical or similar elements are denoted by the same reference signs, and a repeated description of these elements in individual cases is dispensed with. The figures show the subject matter of the present invention only schematically.

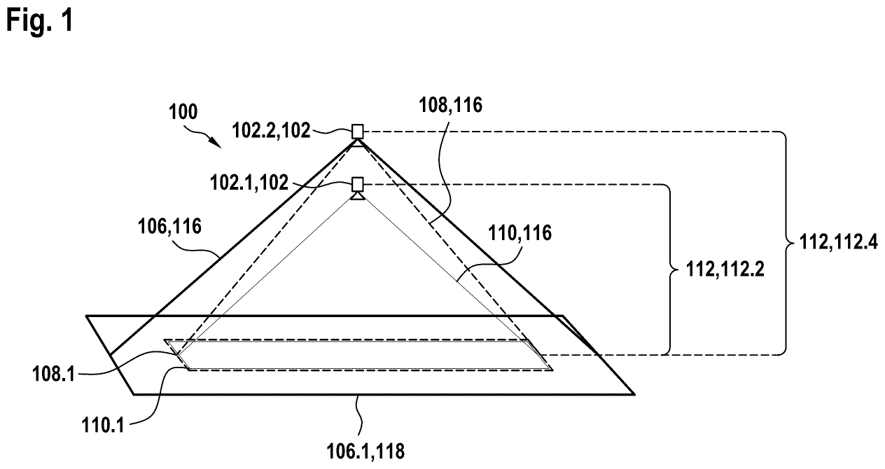

FIG. 1 is a graphical representation of the camera system 100. FIG. 1 is also a representation of a camera 102 for detecting a vehicle's surroundings during an automatic parking process at different installation heights 112 with the dynamic field of view in the image distortion correction. Shown is a first camera 102.1 at a first installation height 112.2 and a first field of view 110 that covers a first region 110.1. Furthermore, FIG. 1 shows a second camera 102.2 at a second installation height 112.4, and a second field of view 106 covering a second region 106.1, wherein the first camera 102.1 and the second camera 102.2 shown are identical cameras that are installed at different installation heights 112. Furthermore, FIG. 1 shows a third field of view 108 or a reduced field of view 108, which covers a third region 108.1. The third field of view 108 is a dynamically used and/or reduced field of view of the distortion-corrected image generated from the cameras 102. The reference sign 116 represents the general representation of the field of view, which comprises the visual information that can be detected of the situation or object under consideration.

As shown in FIG. 1, by reducing the size of the second field of view 106 of the distortion-corrected image 118, or by the virtual camera, the second region 106.1 is reduced in size such that in the object space a third region 108.1 is covered which is similar to the first region 110.1 covered at the second installation height 112.4.

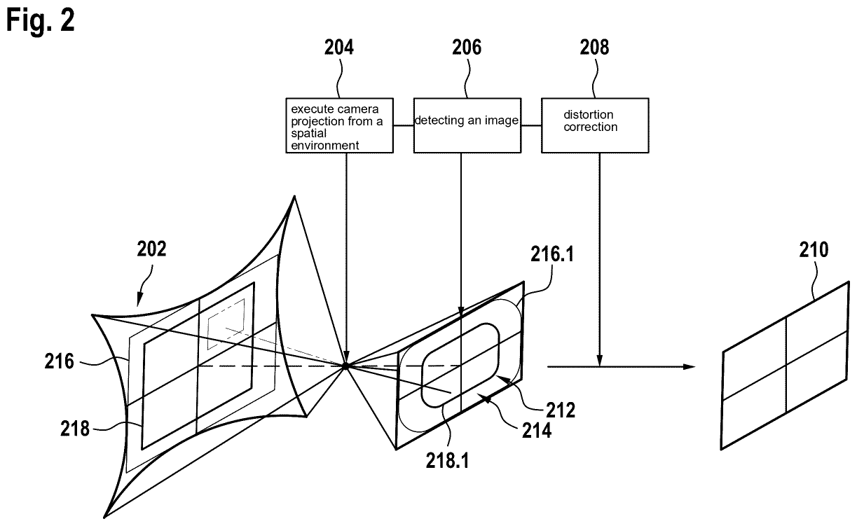

FIG. 2 is a representation of the method 200 and a graphical representation of a dynamic image correction. This method comprises two substantial steps. In the first step of the method 200, the detecting 206 of an image is performed by executing 204 a camera projection from a spatial environment 202, wherein a detected image 214 comprises an original camera resolution, wherein the detected image 214 exhibits the optical distortion 212. In the final, third step, the distortion correction 208 is carried out for an image portion to generate a distortion-free image 210, 302.1, 304.1, 306.1, 402.1, 404.1 with a dynamic field of view.

FIG. 2 is also a graphical representation of a dynamic image correction. The graphical representation of the dynamic image correction shows a spatial environment 202 in which the execution 204 of the camera projection is carried out. The spatial environment 202 further comprises an outer spatial environmental portion 216 and an inner spatial environmental portion 218. After the execution 204 of the camera projection, the detection 206 of an image is carried out. The detected image 214 comprises the distortion-corrected image 118. The distortion-corrected image 118 in turn comprises an outer image portion 216.1 and an inner image portion 218.1, both of which comprise an optical distortion 212. Furthermore, after the recording 206, a distortion correction 208 of the detected image 214 is performed so that a distortion-free image 210 is created. The distortion-free image 210 completely comprises all image information from the region of the inner spatial environmental portion 218.

For example, if image processing is performed on a reduced FOV (as in the AVP application), the desired configuration of the distortion-free image 210, 302.1, 304.1, 306.1, 402.1, 404.1 (reduced field of view 108, ROI/WOI upscaling or magnification scale) should preferably already be taken into account in the distortion correction step 208. This improves the final image quality compared to the related art, since the subpixel interpolation method is performed only once in the original image during the distortion correction 208 for a reduced field of view 108. In the AVP application, for example the desired reduced image portion, which comprises a distortion-free image 210, is first calculated based on the distance between the camera 102 and the object, or the installation height 112 of the camera 102. In this case, the undistorted image 118 intentionally comprises a smaller image portion and some information about the outer parts of the original image from the outer spatial environmental portion 216 is lost, but the image quality in the distortion-free image 210, 302.1, 304.1, 306.1, 402.1, 404.1 (corresponding to the inner environmental portion 218 of the original image of the spatial environment 202) is higher compared to the related art, which leads to a higher accuracy of the image processing algorithm in the inner image portion 218.1 and thus to a more accurate recognition of objects further away. With this technique, the same camera 102 can be used for different installation heights 112, wherein the required recognition accuracy and precision are maintained.

Due to the method 200, an optical magnification (zoom-in effect) is generated in the distortion-corrected image 118. In order to maintain for example a certain image quality, various anti-aliasing techniques, pixel or subpixel interpolation methods can be used to generate the image with a reduced field of view 108.

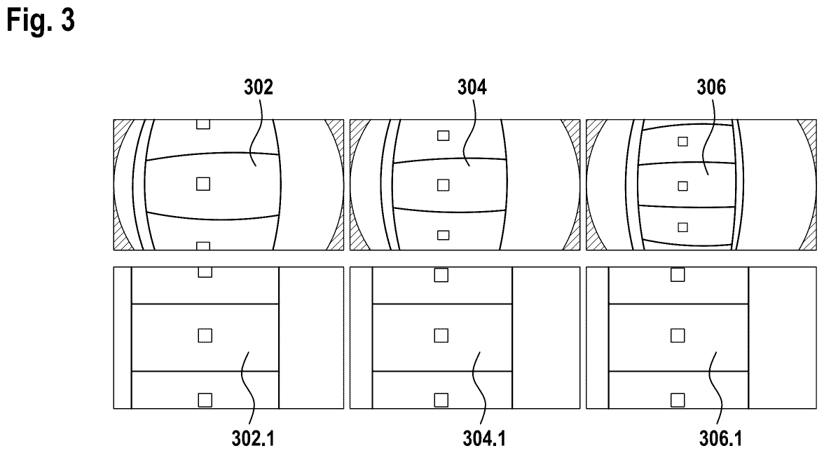

FIG. 3 shows images of an automatic parking system with a dynamic horizontal field of view. The images are recordings from an automatic parking camera (mono or stereo) at different installation heights 112 with the dynamic field of view in the image distortion correction. In the first row, from left to right, original camera images using the same camera are shown, wherein a first camera image 302 is recorded at an installation height 112 of 4 meters, a second camera image 304 is recorded at an installation height 112 of 5 meters and a third camera image 306 is recorded at an installation height 112 of 6 meters. In the second row, from left to right, distortion-free images 302.1, 304.1 and 306.1 of the above images are shown using a dynamic field of view according to the present invention for image distortion correction.

As shown in FIG. 3, by increasing the installation height 112 of the camera while reducing the size of the first field of view 110 in the corrected image, a similar image can be generated, wherein the similar region, namely the first region 110.1, is reduced in size to the second region. The dimensions of the third region 108 are the same, and in these methods 200 the theoretical optical and/or spatial resolution remains the same, while the performance of the perception system 512 is increased.

For example, the quality of the resulting image, namely the resulting image 210, can be further optimized by pixel or subpixel interpolation methods, various anti-aliasing methods, contrast enhancement or similar methods in the method step of distortion correction 208.

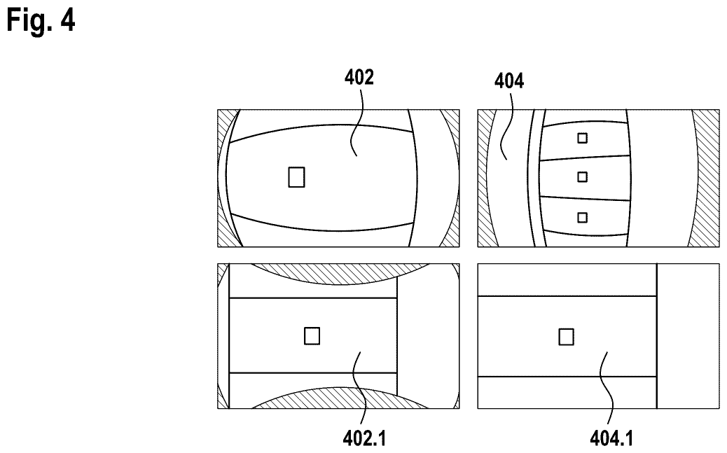

FIG. 4 is a representation of images of an automatic parking system with the dynamic region of interest and the field of view 116. The images are images of a camera for automatic parking (mono or stereo) at different installation heights 112 with the dynamic region of interest and the field of view 116 in the image distortion correction, wherein an object size, at least one image feature and a resolution are an object-space measurement and are similar at different installation heights 112. In the first row from left to right, original camera images using the same camera are shown, wherein a fourth camera image 402 is recorded at a 2.5 m installation height 112 and a fifth camera image 404 is recorded at a 4 m installation height 112. In the second row, from left to right, distortion-free images 402.1, 404.1 of the above images are shown using a dynamic region of interest and a field of view 116 according to the present invention for image distortion correction.

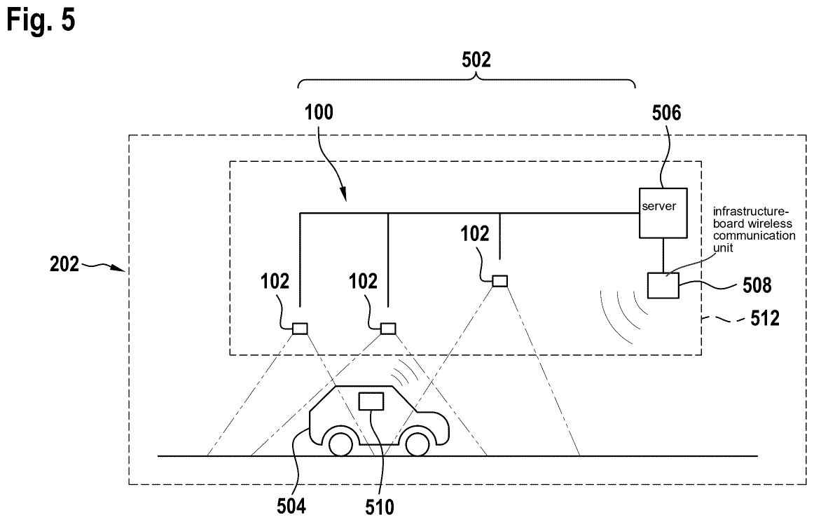

FIG. 5 is a graphical representation of a horizontal arrangement 502 of three cameras 102 of the camera system 100, which is provided for image distortion correction of an image region in the perception system 512. The graphical representation of FIG. 5 shows a spatial environment 202, for example a parking garage, and an autonomous vehicle 504, which comprises a vehicle communication unit 510. It is further shown that the perception system 512 comprises a server 506 and an infrastructure-bound wireless communication unit 508. The spatial environment 202 detected by the camera system 100 is transmitted to the vehicle communication unit 510 of the autonomous vehicle 504 by means of the infrastructure-bound wireless communication unit 508.

The present invention is not limited to the embodiments described here and the aspects emphasized therein. Rather, a large number of modifications are possible within the scope of the present invention, which are within the scope of the activities of a person skilled in the art.

What is claimed is:

1. A camera system for increasing the performance of a perception system for image correction of an image region, the camera system comprising:
one or more cameras, each having a focal length with a field of view, wherein the one or more cameras includes a uniform camera type or a uniform camera variant;
wherein the one or more cameras can be positioned at different installation heights or object distances from the camera, wherein a virtual camera and/or virtual image is generated from a camera image using the camera system, wherein a focal length and a field of view of the virtual image changes dynamically once during an installation or multiple times when the environmental conditions change, depending on an installation height or the object distance.

2. The camera system according to claim 1, wherein each of the at least one camera is a super-wide-angle camera.

3. The camera system according to claim 1, wherein the generated camera image is a raw image or a distortion-free image.

4. The camera system according to claim 1, wherein one or more cameras have a dynamic region of interest and the focal length.

5. The camera system according to claim 1, wherein the camera system comprises an arrangement of a plurality of cameras in a configured position and orientation relative to one another, wherein the position and the orientation of the cameras is configured in such a way that optimum coverage of the region to be monitored is achieved.

6. A method for increasing the performance of a perception system for image distortion correction of an image region, with a camera system, wherein the method comprises the following steps:
detecting an image by performing a camera projection from a spatial environment, wherein a detected image includes an original camera resolution, wherein the detected image includes an optical distortion; and
distortion correcting for generating a distortion-free image with a dynamic field of view.

7. The method according to claim 1, wherein the camera system includes:
one or more cameras, each having a focal length with a field of view, wherein the one or more cameras includes a uniform camera type or a uniform camera variant;
wherein the one or more cameras can be positioned at different installation heights or object distances from the camera, wherein a virtual camera and/or virtual image is generated from a camera image using the camera system, wherein a focal length and a field of view of the virtual image changes dynamically once during an installation or multiple times when the environmental conditions change, depending on an installation height or the object distance

8. The method according to claim 6, wherein by reducing the size of the first region of the distortion-corrected image, a size of the first region is achieved which is similar to a size of a third region.

9. The method according to claim 6, wherein the method further comprises generating a virtual camera or a virtual distortion-free image from a raw image in one step.

10. The method according to claim 6, wherein a digital or synthetic dynamic zoom-in effect is generated in a resulting image.

11. The camera system according to claim 1, wherein the camera system is used for increasing the performance of a perception system for image distortion correction of an image region within an automatic parking system.
